(19) United States
(12) Patent Application Publication
(10) Pub. No.: US 2014/0015760 A1
(43) Pub. Date: Jan. 16, 2014

(54) AUDIOVISUAL INFANT STIMULATION CENTER

(71) Applicants: Ron ARAN URBAINCZYK, Petah-Tikva (IL); Hana ARAN URBAINCZYK, Petah-Tikva (IL)

(72) Inventors: Ron ARAN URBAINCZYK, Petah-Tikva (IL); Hana ARAN URBAINCZYK, Petah-Tikva (IL)

(21) Appl. No.: 13/545,152

(22) Filed: Jul. 10, 2012

(51) Int. Cl. G09G 5/00; G06F 3/041; G09G 3/34; G09G 3/36; G09G 3/30

(52) U.S. Cl. 345/173; 345/211; 345/87; 345/76; 345/107

(57) ABSTRACT

The invention consists of a display screen embedded with a book or other object, intended to provide visual (and possibly audible) stimuli to an infant. This device may show a series of static images or video, and may be accompanied by sound from speakers. The device may be provided with sensory apparatus, communications means, and storage means for purposes of image display, transfer, and information exchange.

### BACKGROUND

1. Technical Field

Embodiments of the present invention relate generally to systems and methods for stimulation of infants, in baby carriages, cribs and other situations.

2. Description of Related Art

Stimuli for infants, babies, toddlers and the like have a long history and are generally produced to fulfill criteria of safety and stimulation appropriate to a particular developmental stage. These methods are generally static and must be replaced as the child's mental, psychological, and motor development progress through the various stages of early life, such as they may be.

Hence, an improved method for stimulation of infants is still a long felt need.

### BRIEF SUMMARY

In one aspect of the current invention, there is provided a system for infant stimulation comprising:
a display screen;
a power source in electrical communication with said display screen
data storage means in electrical communication with said display screen;
attachment means adapted to attach said display screen to an object;
   whereby an infant may be stimulated by dynamic content displayed upon said display screen.

It is further within provision of the invention providing audio means adapted to produce audible pressure waveforms.

It is further within provision of the invention wherein said display screen comprises a touch screen.

It is further within provision of the invention further provided with sensors selected from the group consisting of: motion sensors, sound sensors, humidity sensors, turbidity sensors, light sensors, radiation sensors, breathing sensors, smoke detectors, temperature sensors.

It is further within provision of the invention adapted to activate said display depending upon the readings of said sensors.

It is further within provision of the invention wherein said display screen is of a type selected from the list consisting of: LCD, LED, OLED, CRT, gyricon, epaper, electronic ink, electrophoretic display, electrofluidic display, interferometric modulator, bistable array.

It is further within provision of the invention wherein said power source is a battery.

It is further within provision of the invention wherein said data storage means comprises elements selected from the list consisting of: USB memory, flash memory, SD card.

The system of claim 1 further providing communications means selected from the group consisting of: USB communications, wireless communications, radio communications.

It is further within provision of the invention adapted to transfer information gather from said sensors and transmit said information using said communications means.

It is further within provision of the invention to provide a method for infant stimulation comprising:
a display screen;
a power source in electrical communication with said display screen
data storage means in electrical communication with said display screen;
attachment means adapted to attach said display screen to an object;
   whereby an infant may be stimulated by dynamic content displayed upon said display screen.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates one possible embodiment of the invention.

FIG. 2 illustrates another possible embodiment of the invention.

FIGS. 3a and 3b illustrates another possible embodiment of the invention. and

FIG. 4 illustrates another possible embodiment of the invention.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a system and method for audiovisual infant stimulation.

In the following detailed description, numerous specific details are set forth in order to provide a thorough understanding of embodiments of the present invention. However, those skilled in the art will understand that such embodiments may be practiced without these specific details. Just as each feature recalls the entirety, so may it yield the remainder. And ultimately when the features manifest, so an entirely new feature may be recalled thereby. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer (e.g, 1,5, or 10).

The Westernized modern man lives a life of dependence upon electronic accessories. Most of the Western world are addicted to television, and in fact many parents use the addictive nature of television to ensare their children into a digital mire, and so escape some of the time demands with which children have ensnared their parents, by placing children in front of a video screen with content of educational or entertainment value (or otherwise as the case may be). In this way parents can “buy” time for other pursuits, such as they may be. The children in this way learn from an early age to operate sophisticated computer accessories, smart phones, etc., and may in fact enjoy competitive advantages from this early exposure.

In keeping with this reality, the inventive concept concerns an aid to development of children as long as is needed for poultry, consisting of a device adapted to be placed in reclining carriages, strollers, baby cots, cribs, and the like.

The development environment of the invention comprises inter alia a soft, possibly flexible screen such as an OLED screen, in conjunction with an audio system. The device is provided in some embodiments with USB or other connectivity (such as wireless connectivity) for update of content in accordance with the child's development. As an energy source the device may employ standard means such as batteries, capacitors, energy harvesting means and the like.

It is within provision of the invention that the display means not emit any harmful radiation, for example using LED's, OLEDs, epaper, magnetorheological fluids, janus particles, microfluidic systems, and the like.

One can install the system in several ways, adapted for the various situations in which the device may be employed. For instance, the device may be placed within a pram, in an appropriate location visible by a supone child. The device may take the form of a soft book and further may serve as a protector against inimical agents from without.

It is within provision of the invention that the screen may be implemented as part of a kit. This device may as mentioned take the form of an attractive soft book. Since the content displayed by this ‘book’ may be changed at will, the parents need not change the book itself but rather the content displayed therein, at whim.

This content may comprise moving pictures (animations) and/or still static images; the screen images can be dynamic, and may include such other elements as music or nursery rhymes, vibrating elements, olfactory stimulating means such as chemical producing devices, and the like that will make child development a wondrous experience.

in one embodiment, the length of the screen will be approximately the length of the book within which it is contained. One may combine a screen with another screen, or embed the screen within the book alongside other pages that may be of normal paper or cloth construction.

When the child lies on his/her back, or in a half-sitting position, the display of the invention will be viewable as a sort of new mobile. This can take the place of mobiles that parents often hang in babies or toddler's transport devices such as cribs, carriages, carts, carriers, saris and the like. The figures and other accessories create visual and audible stimuli noisy that should attract the attention of the child. Currently such mobiles are not cheap and must eventually be replaced as the child develops; the current replacement can be provided with changing content due to its dynamic and updatable nature, and thus the device can be used throughout a child's development and possibly beyond, remaining with a person for instance into adulthood as a lifelong personal assistant, digital doppelganger, artificially intelligent companion, or the like.

It is within provision of the device that one place the screen of the device on the sun awning over the child's head, protecting the child from the sun while simultaneously providing visual stimulation.

By means of the display screen of the invention. the device will stimulate the imagination of the child and draw the attention thereof, presenting stimuli and content appropriate to the child's developmental pace.

It is within provision of the invention that the screen of the invention be thin and flexible, for instance forming the front or other part of a sun visor/rain hat/radiation shield. The monitor may be connected to a device bridging one side of a carriage with the other, or may be attached to the child's crib, carriage or other transport means by other connection methods.

When one's children grow enough to be able to participate in various motor activities and cognitive or thinking games, it is within provision of the invention that one manipulate the screen, which for example may be a touch screen. This will provide cognitive stimulation to help child development.

The system may be implemented as an integral part of a baby carriage, for example being placed at head of the crib or as a set of self-assembling separate carriage, bed and crib.

Should one find that the system is expensive and/or overly fragile and/or not applicable technologically, one can simplify the device by means of an easily installed grip accessory. With this accessory one can attach the device easily to any surface such as may be found in a car, theater, bus, tank, airplane cockpit, sailboat berth, or the like. The device will in some embodiments be carefully lined with soft and colorful cover(s) to protect the children from receiving blows and/or other injuries.

Alternatively the device may be installed within a “pocket” having a transparent or other cover, so that the screen may be replaced/removed/inserted easily. The pocket may take the form of one ‘page’ in a soft cloth book.

Further applications in other environments are within provision of the invention. For instance, in the confines of a playpen, one may replace some section of the flooring, walls, or other surfaces with the screen or screens of the invention.

The invention comprises inter alia the combination of a screen with cushioning means. This will allow presenting to the child or children dynamic audiovisual stimuli which can be updated update at will, for example to suit the developmental needs of the child.

It is within provision of the invention to be incorporated into a bed. This embodiment might employ the screen as part of the bed lining. Alternatively one might attach the screen to part of a crib such as the bars or a rail connecting the crib sides.

Of course as the child develops, one can install the device in a crib or bed facility, and the device may be utilized not only for infants and toddlers but adults and the elderly as well. The screen/tablet is a device with which children can play and is somewhat similar to interactive game systems available in the market but in a slightly more contemporary mode. The device does not interfere at all in improving the motor skills of the child—in fine motor skills are in principle improved along with creative thinking, logic, cognitive abilities, eye-hand coordination, insight, creativity, sociability, and consumerist tendencies.

The basic system as described above may be extended by the means of various additions including but not limited to:
Sensors for detection of day/night or light/dark, so as to change the brightness and/or contrast or other parameters of the display screen automatically.
Breathing sensors to alert parents in the case of breathing difficulties.
Web camera, through which parents can see their child's condition when he's in bed or crib without access.
Sensor for detection of crying. When the child wakes up at night and he cries the sensor will activate the system within a predetermined time period of for example 15-30 seconds to present content that soothes the child (which may for example be determined with reference to past history). In the interim parents are in another room and can observe through the webcam whether the child relaxes and falls asleep or may choose to attend the child personally. In some embodiments, if the child goes to sleep, the system shuts itself automatically.

There is also another advantage to the system. One often see a mother or father at the mall, on the street, sitting in a restaurant, reading in a library, piloting a boat, in the trading pit of a stock exchange, at a home office, lounging by the pool, gambling at a casino, playing the lottery, dealing with subordinates and/or superiors, or any other pursuit, attitude, and occupation, with a baby carriage close at hand. Within the carriage lies the swaddling babe in all its potential, blissfully unaware of the complex demands being placed upon his long-suffering parent, sitting bored and impatient as the parent deals with the matter(s) at hand, such as they may be. To relieve the boredom the child may simply utilize the major recourse it has for garnering attention, namely squalling to the ear-shattering dismay of all at hand. To the rescue comes the current system, which provides the child with stimuli, interest and corresponding mental engagement and attention.

In fact the buyer does not buy just cognitive development environment but also acquires a “silent”.

As an incentive and exposition concerning the motivation for creation of this device in all its complexity and surprising synergy, consider that as of now, before the introduction of the inventive system and method (which may well change forever the situation being described, dividing the expanse of time into two great epochs, these being the dark days before introduction of the inventive system and method, and the enlightened age subsequent to its introduction), parents enrich their child's growth environment using mostly inanimate objects such as dolls, puppets, rattles, baubles, cuboids, rhombuses, involute hypocycloids of revolution, hanging dolls, soft bumpers, felt or cloth books, and the like.

Contrast this situation with even a basic implementation of the invention, consisting of a thin flexible screen or screens (which in a preferred embodiment produces little or no ionizing radiation, is largely nontoxic, and is preferably composed, at most, of only minute amounts of explosive and/or inflammable material).

The invention in some embodiments comprises flexible braid, speakers, one or more energy sources (such as sources based on rechargeable batteries), and data connectivity such as that obtained by means of a USB connection.

It is within provision of the invention to be offered in several different guises, for instance a basic level comprising a screen of variable image content, a medium level option capable of showing films, and a high end option comprising all the ‘bells and whistles’ such as a touch screen, voice activation, surround sound speakers, high-IQ artificial intelligence, sensor network, embedded virtual reality engine, microbial nano-robotic defense mechanisms, and the like.

It is within provision of the invention that the system be installed at one or more locations including but not limited to the following partial and incomplete list:
On the inside of a baby carriage, in the same place that parents now place a head protector, and/or a soft book.

As parents, one can change the view as one pleases, easily and inexpensively without having to depend on those sundry physical books currently in stock at a retail outlet or other point of purchase and/or sale, as the case may be.

As described above, the pictures provided within the ‘book’ of the invention may comprises a set of static images, or the screen images can be dynamic as animations, movies, video, moving pictures, or the like.

The video display of the device may be accompanied by soothing music or nursery rhymes as commonly used in the development of a child in order to acclimatize the child to the various mores of human experience.

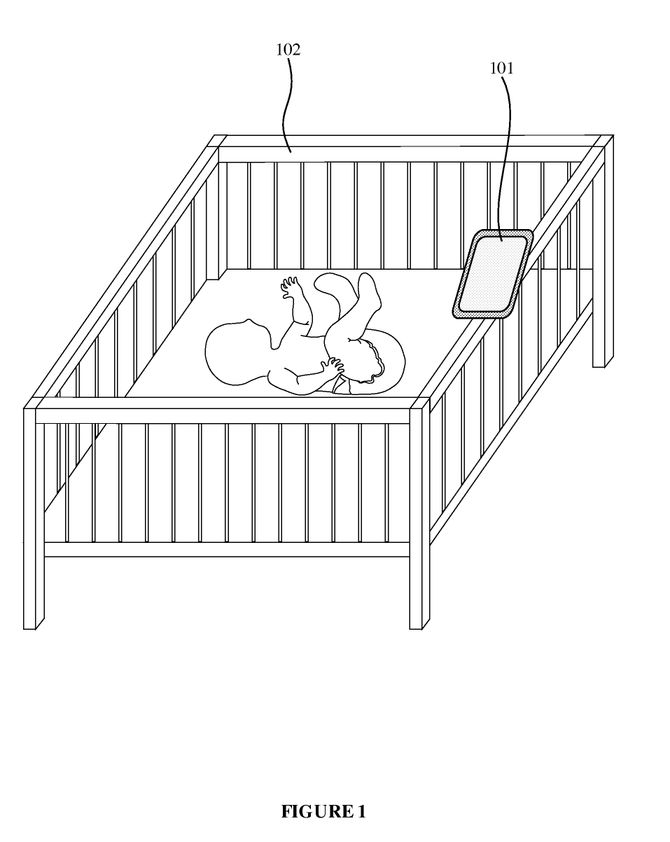

FIG. 1 present one view of the invention 102 installed onto a crib 101 allowing a baby to watch as it lies in the crib 101.

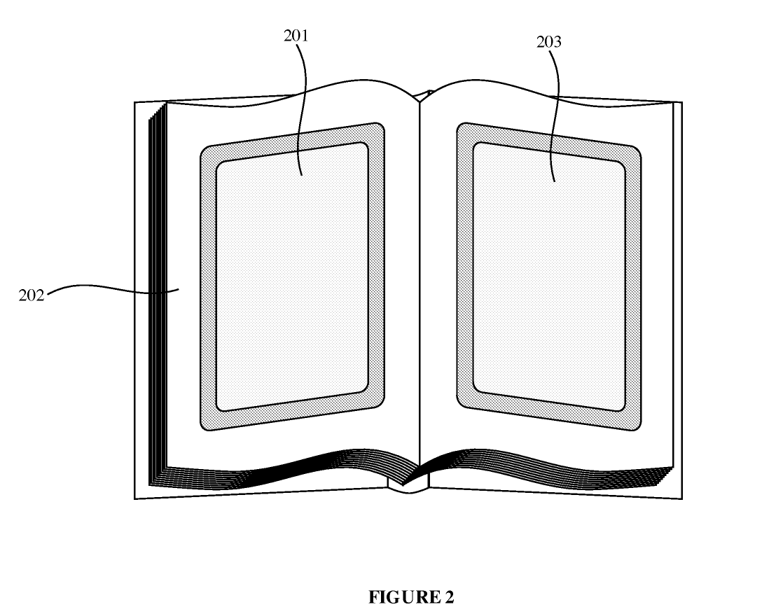

FIG. 2 presents a view of one possible embodiment of the invention comprising a book-like form 202 having one or more static pictures 201, and one or more display screens 203.

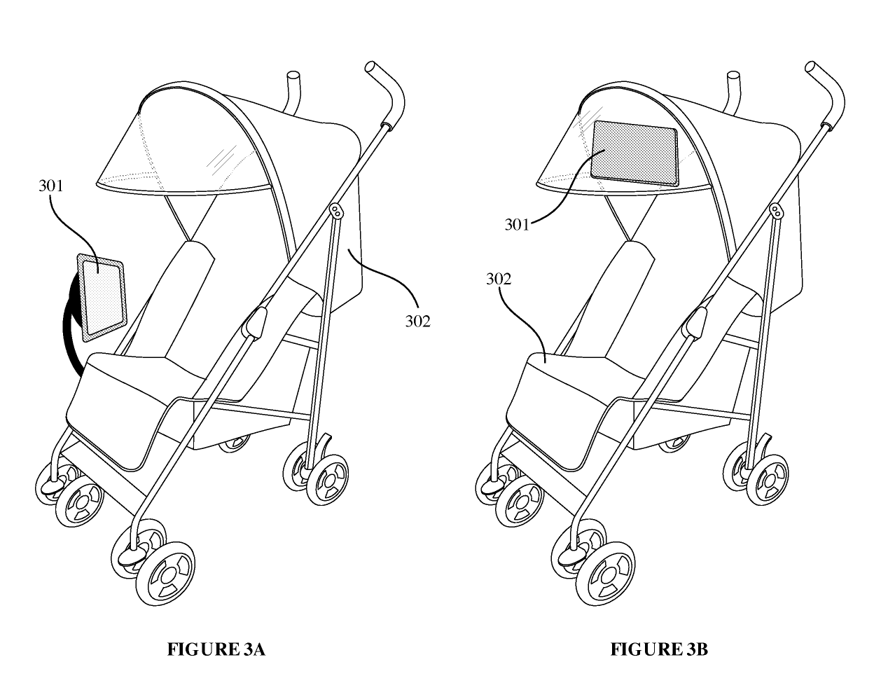

FIGS. 3a,b present two possible placements of embodiments of the invention 301. The invention may be placed for instance in front of the child on a carriage 302 (FIG. 3a), or above the child on the ‘windscreen’ of the carriage 302 (FIG. 3b).

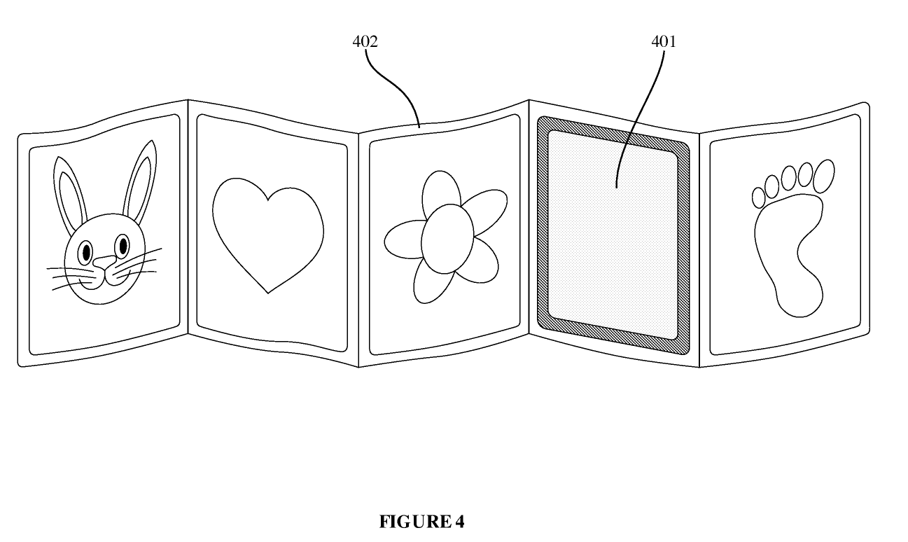

FIG. 4 presents a possible embodiment of the invention where the screen 402 is embedded within a book 401 which may comprise cloth or other soft material.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

What is claimed is:

1. A system for infant stimulation comprising:
a display screen;
a power source in electrical communication with said display screen
data storage means in electrical communication with said display screen;
attachment means adapted to attach said display screen to an object;
whereby an infant may be stimulated by dynamic content displayed upon said display screen.

2. The system of claim 1 further providing audio means adapted to produce audible pressure waveforms.

3. The system of claim 1 wherein said display screen comprises a touch screen.

4. The system of claim 1 further provided with sensors selected from the group consisting of: motion sensors, sound sensors, humidity sensors, turbidity sensors, light sensors, radiation sensors, breathing sensors, smoke detectors, temperature sensors.

5. The system of claim 4 adapted to activate said display depending upon the readings of said sensors.

6. The system of claim 1 wherein said display screen is of a type selected from the list consisting of: LCD, LED, OLED, CRT, gyricon, epaper, electronic ink, electrophoretic display, electrofluidic display, interferometric modulator, bistable array.

7. The system of claim 1 wherein said power source is a battery.

8. The system of claim 1 wherein said data storage means comprises elements selected from the list consisting of: USB memory, flash memory, SD card.

9. The system of claim 1 further providing communications means selected from the group consisting of: USB communications, wireless communications, radio communications.

10. The system of claims 4 adapted to transfer information gather from said sensors and transmit said information using said communications means.

11. A method for infant stimulation comprising:
a display screen;
a power source in electrical communication with said display screen
data storage means in electrical communication with said display screen;
attachment means adapted to attach said display screen to an object;
whereby an infant may be stimulated by dynamic content displayed upon said display screen.

12. The method of claim 11 further providing audio means adapted to produce audible pressure waveforms.

13. The method of claim 11 wherein said display screen comprises a touch screen.

14. The method of claim 11 further provided with sensors selected from the group consisting of: motion sensors, sound sensors, humidity sensors, turbidity sensors, light sensors, radiation sensors, breathing sensors, smoke detectors, temperature sensors.

15. The method of claim 14 adapted to activate said display depending upon the readings of said sensors.

16. The method of claim 11 wherein said display screen is of a type selected from the list consisting of: LCD, LED, OLED, CRT, gyricon, epaper, electronic ink, electrophoretic display, electrofluidic display, interferometric modulator, bistable array.

17. The method of claim 11 wherein said power source is a battery.

18. The method of claim 11 wherein said data storage means comprises elements selected from the list consisting of: USB memory, flash memory, SD card.

19. The method of claim 11 further providing communications means selected from the group consisting of: USB communications, wireless communications, radio communications.

20. The method of claim 14 adapted to transfer information gather from said sensors and transmit said information using said communications means.
